(19) United States
(12) Patent Application Publication
(10) Pub. No.: US 2008/0302602 A1
(43) Pub. Date: Dec. 11, 2008

(54) Mobile Hydraulic lift

(76) Inventors: Larry Schultz, Alexandria, MN (US); Darrell Schultz, Osakis, MN (US); James Jabas, Alexandria, MN (US)

Correspondence Address: John M. Weyrauch;DICKE, BILLIG & CZAJA, PLLC, Suite 2250, 100 South Fifth Street, Minneapolis, MN, 55402, US

(21) Appl. No.: 11/810,527

(22) Filed: Jun. 6, 2007

(51) Int. Cl. B66B 9/04; B60P 1/00; B66F 11/04

(52) U.S. Cl. 182/69.4; 414/438

(57) ABSTRACT

A mobile hydraulic lift comprises a trailer having a frame configured for towing behind a vehicle. The frame includes a longitudinally extending frame member with telescoping end portions on front and rear ends of the frame member. The front end telescoping portion includes a ball hitch connector and a jackstand for supporting the front end of the longitudinally extending frame member when it is disconnected from the vehicle. The rear end telescoping portion also includes a jackstand. The frame also includes a transversely extending frame member with telescoping end portions on opposing ends of the transversely extending frame member. Each telescoping end portion of the transversely extending frame member carries a wheel. The frame defines one footprint when the telescoping end portions of the longitudinally extending frame member and the transversely extending frame member are retracted within the respective frame members and a larger footprint when the telescoping end portions are extended from the respective frame members. The frame carries a single, multi-stage hydraulic cylinder that has one end secured to the frame. A plurality of legs connect to the housing of the hydraulic cylinder and the frame to support the hydraulic cylinder in a generally perpendicular position relative to the frame. A second end of the hydraulic cylinder is connected to a main support beam of a platform.

### BACKGROUND

The present invention is generally related to hydraulic lifts and more specifically is related to a mobile hydraulic lift particularly suited for accessing remote locations and elevating a platform from which an occupant can observe his or her surroundings.

### SUMMARY

The present invention is a mobile hydraulic lift comprising a trailer, a multi-stage hydraulic cylinder having a first end connected to the trailer and a second end connected to a platform. The trailer comprises a trailer frame which has a variable length first end member, a variable length second end member, a variable length first side member and a variable length second side member. The trailer frame defines a first footprint when the first and second end members and the first and second side members are in a first position, and a second footprint greater than the first footprint when the first and second end members and the first and second side members are in a second position. The first and second end members each configured with a ground contact device and the first and second side members each carrying a wheel. The multi-stage hydraulic cylinder has first, second and third cylinder housings. A first end of the first cylinder housing connects to the trailer frame and a first end of the third cylinder housing defines a connector. The hydraulic cylinder is operably coupled to a battery-operated hydraulic system comprising a hydraulic reservoir and a hydraulic pump. The first cylinder housing is maintained generally perpendicular to the trailer frame by a support connected between the first cylinder housing and the trailer frame. The platform has a perimeter deck frame comprised of a plurality of deck frame members and a central box beam extending between and connected to two opposing perimeter deck frame members at their respective midpoints. The deck frame and the box beam has an upper surface supporting a deck of the platform. The box beam further has a lower surface. The connector of the hydraulic cylinder is connected to the central box beam.

### BRIEF DESCRIPTION OF THE DRAWINGS

FIG. 1 is a side view of the mobile hydraulic lift system of the present invention in tow behind an all terrain vehicle.

FIG. 2 is a top plan view of one embodiment of a trailer chassis of the mobile hydraulic lift system of FIG. 1.

FIG. 3 is a cross-sectional view of the mobile hydraulic lift system of FIG. 1 taken along line 3-3.

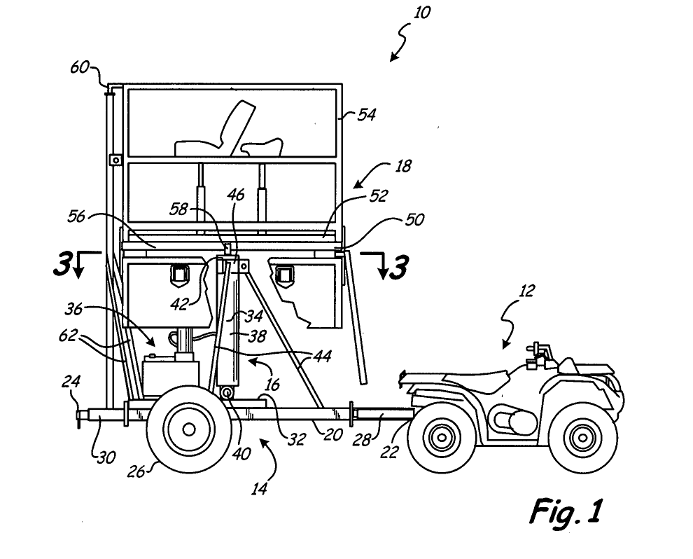

FIG. 1 is a side view of the mobile hydraulic lift system of the present invention in tow behind an all terrain vehicle.

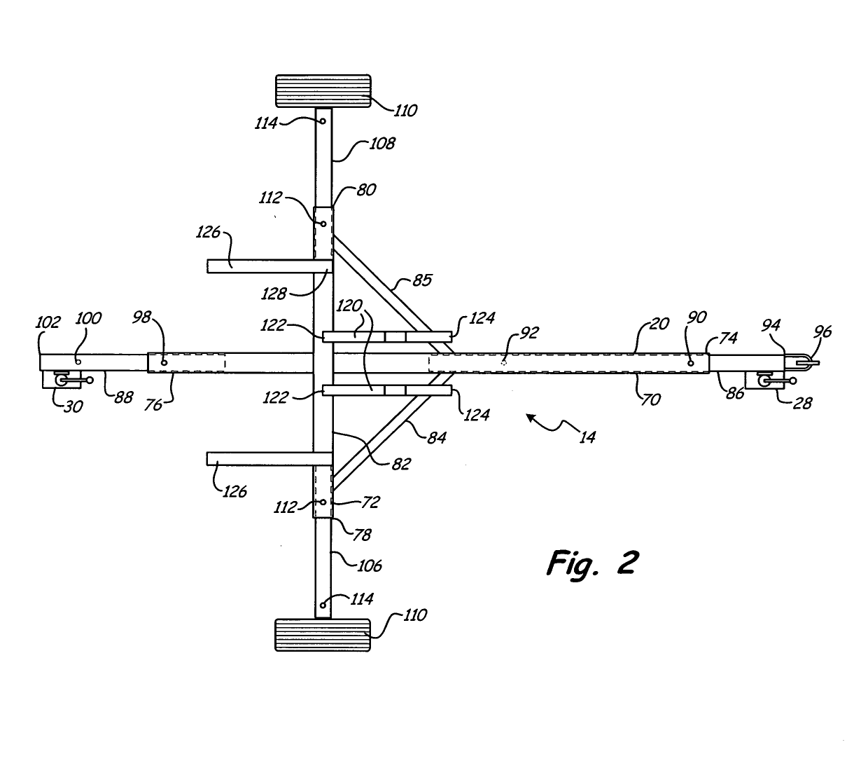

FIG. 2 is a top plan view of one embodiment of a trailer chassis of the mobile hydraulic lift system of FIG. 1.

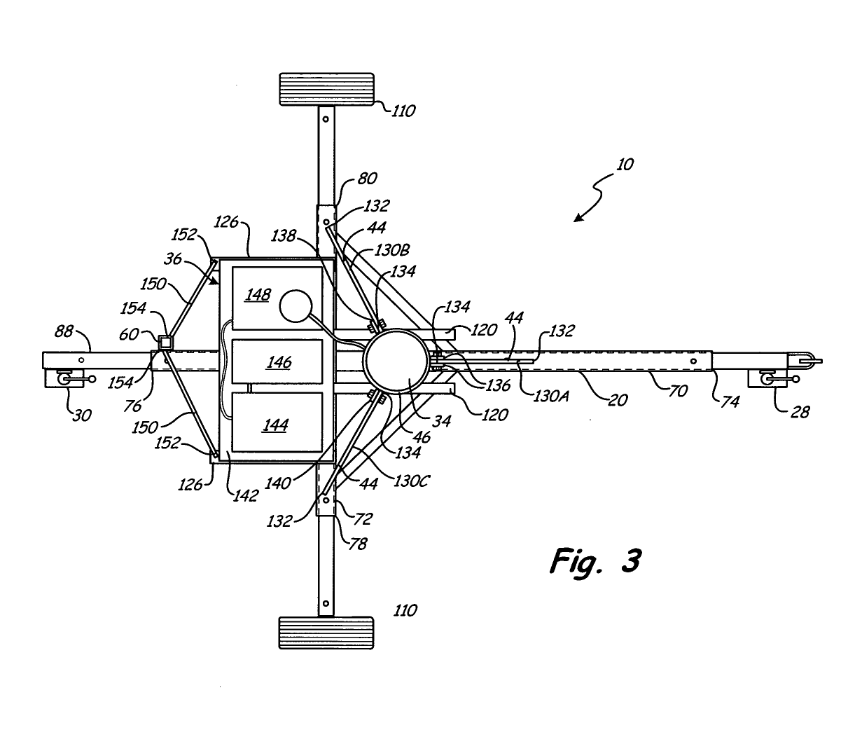

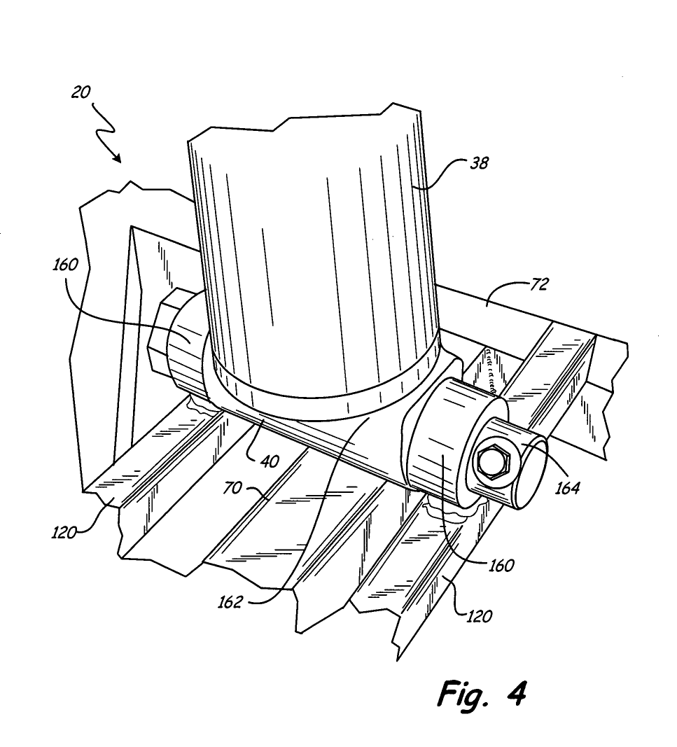

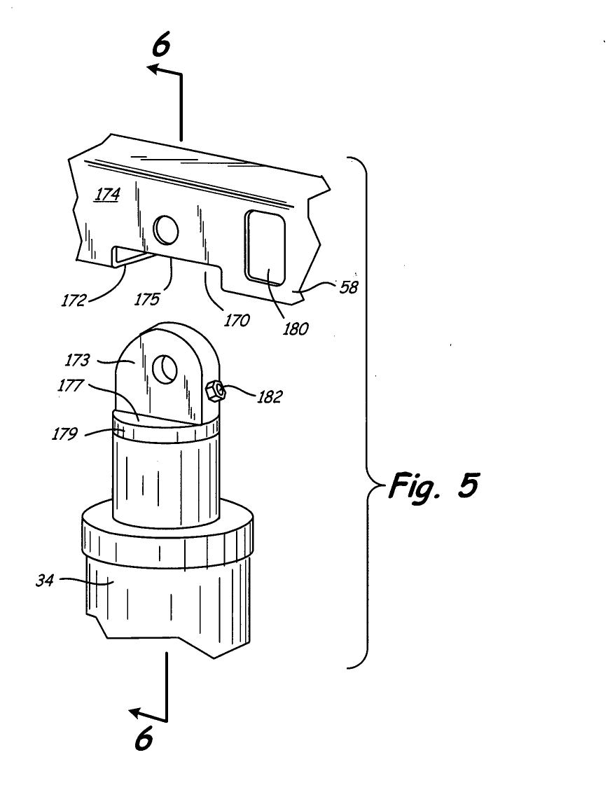

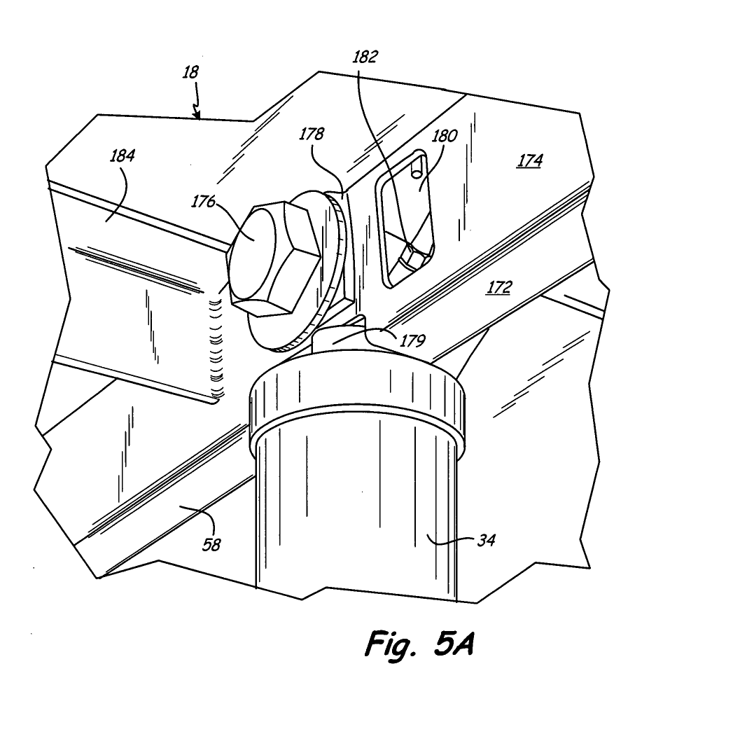

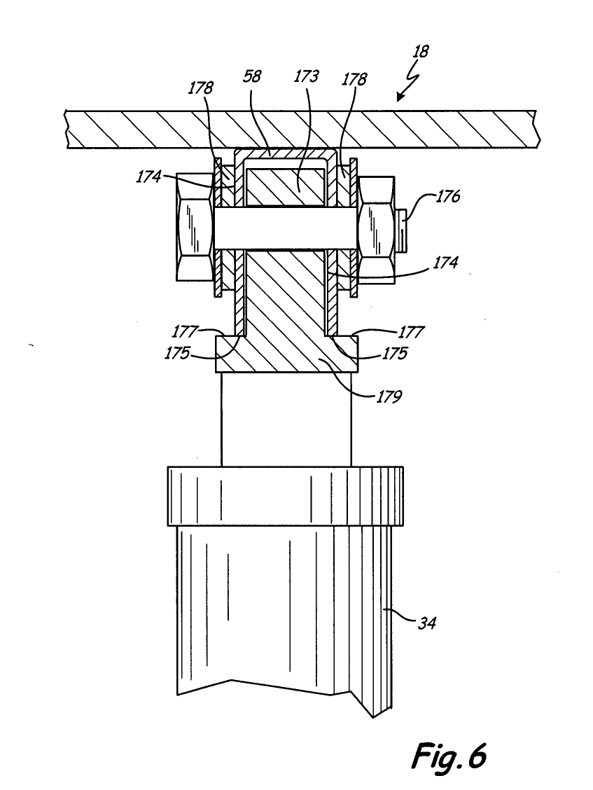

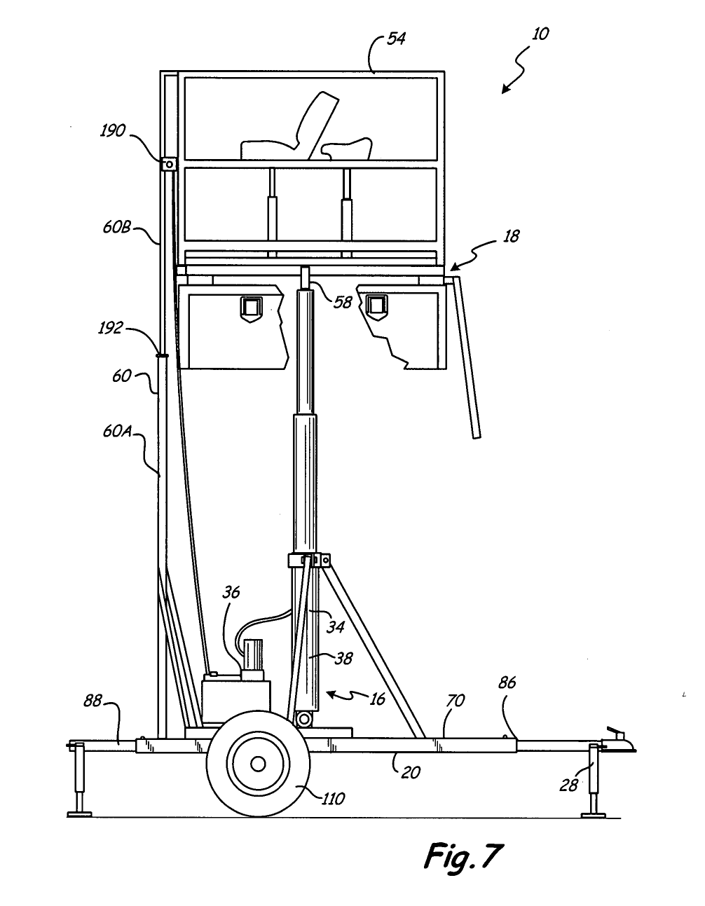

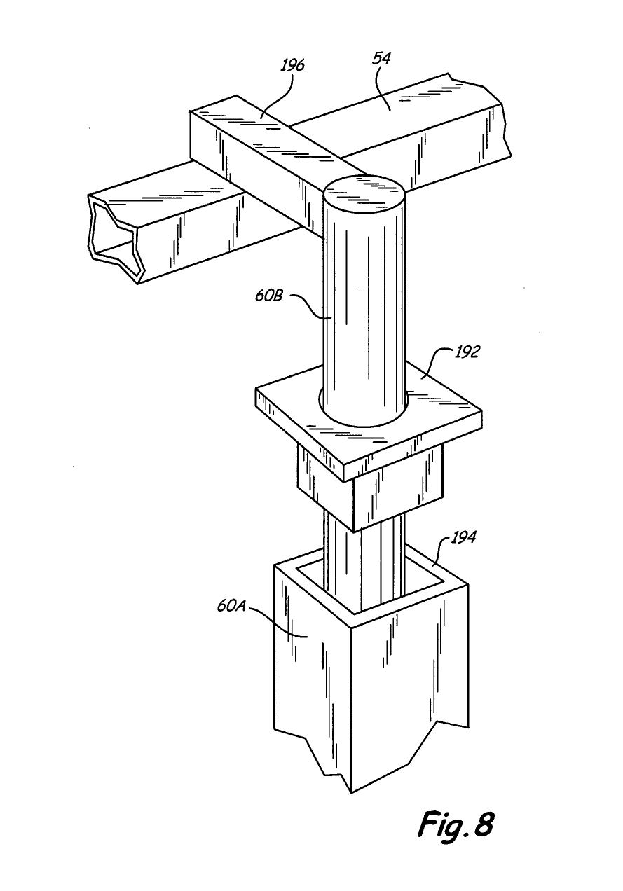

FIG. 3 is a cross-sectional view of the mobile hydraulic lift system of FIG. 1 taken along line 3-3.

FIG. 4 is an enlarged view of a bottom portion of the hydraulic cylinder connected to a base on the trailer chassis.

FIG. 5 is an exploded partial perspective view of a top portion of the hydraulic cylinder and a platform support beam.

FIG. 5A is an enlarged view of a top portion of the hydraulic cylinder connected to a platform support beam.

FIG. 6 is a cross sectional view of the platform support beam/hydraulic cylinder connection taken along line 6-6 of FIG. 5.

FIG. 7 is an enlarged end view of a telescoping stabilizing rod connected to a railing of the platform.

FIG. 8 is a side view of the mobile hydraulic lift system in a deployed condition.

### DETAILED DESCRIPTION

FIG. 1 is a side view of the mobile hydraulic lift system 10 of the present invention in tow behind an all terrain vehicle 12. Lift system 10 is generally comprised of a wheeled trailer chassis 14, a hydraulic lift system 16 connected to chassis 14 and a platform 18 connected to hydraulic lift system 16. In one exemplary embodiment, chassis 14 includes a frame 20 having a front end 22 and a rear end 24. Front end 22 is provided with a ball hitch coupler (not shown) for connecting to a towing ball of a vehicle towing system. Frame 20 is supported on a pair of wheels 26 which allows lift system 10 to be towed to a remote location for use as an elevated deer hunting stand. A pair of jackstands 28, 30 are mounted to frame 20 adjacent to front end 22 and rear end 24, respectively. Jackstands 28, 30 are swivel-type, height-adjustable jackstands that can pivot from a horizontal position (as shown in FIG. 1) to a vertical position to support the ends of the trailer frame 20 when lift system 10 is not connected to a vehicle. Supported on frame 20 is a base 32 for connecting and supporting a telescopic hydraulic cylinder 34 of the hydraulic lift system 16.

The hydraulic lift system 16 is comprised of the telescopic hydraulic cylinder 34 and a battery-operated hydraulic system 36 carried on frame 20. In one exemplary embodiment, hydraulic cylinder 34 is a three-stage telescopic hydraulic cylinder, part number 70892-53-84 manufactured by Hyco, Inc. of Arab, Ala. Hydraulic cylinder 34 has a base housing 38 with a first end 40 which mounts to base 32 and a second end 42, from which the second and third stages of hydraulic cylinder 34 extend. In one embodiment, hydraulic cylinder 34 is supported generally perpendicular relative to frame 20 by a plurality of legs 44 which are connected to and extend from frame 20 to a point adjacent to second end 42 of hydraulic cylinder 34. In one embodiment, legs 44 connect to a collar 46 secured to the base housing 38 adjacent to the second end 42.

Hydraulic cylinder 34 is connected to the battery-operated hydraulic system 36 that includes a fluid reservoir, a hydraulic pump and a 12 volt battery. By way of example, the fluid reservoir can be a seven gallon reservoir from SunSource Mobile Hydraulic Systems of Savage, Minnesota, part number SA-2861, and the hydraulic pump can be Fenner Stone part number SPX#2000533 also available from SunSource Mobile Hydraulic Systems.

Platform 18 is generally comprised of a deck frame 50 which supports a deck 52 and a perimeter railing 54. In one embodiment, deck frame 50 is constructed of a plurality of metal perimeter frame members 56 and a central metal beam 58 that extends between two opposing frame members 56. In one embodiment, frame members 56 and metal beam 58 each have a length of about 5 feet. Central beam 58 is secured to two opposite perimeter frame members 56 by welding. In one embodiment, central beam 58 is a 2 inch by 4 inch steel box beam. Central beam 58 is connected to hydraulic cylinder 34 and in conjunction with perimeter frame members 56 supports deck 52. Deck 52 may be formed from plywood or other suitable decking material. A utility box (shown partially broken away) and ladder may be connected to deck frame 50.

By way of example, railing 54 is constructed from metal tubing and is secured to the perimeter frame members 56 by welding. Railing 54 is secured to a telescoping rod 60 that is connected to and extends vertically from frame 20. Rod 60 prevents platform 18 from rotating about hydraulic cylinder 34. In one embodiment, rod 60 is supported by a pair of metal supports 62 that connect between rod 60 and a portion of frame 20.

FIG. 2 is a top plan view of one exemplary embodiment of chassis 14 with hydraulic lift system 16 and platform 18 removed. As shown in FIG. 2, frame 20 is generally comprised of a longitudinally extending frame member 70 and a transverse frame member 72. In one embodiment, frame members 70 and 72 are formed from 3 inch square metal tubing and are secured to each other by welding. Frame member 70 extends from first end 74 to second end 76 and in one exemplary embodiment has a length of about 85 inches. Transverse frame member 72 includes a first end 78, a second end 80 and a first side 82. First side 82 of transverse frame member 72 is located about 57 inches from first end 74 of longitudinal frame member 70. Frame member 72 is supported relative to frame member 70 by a pair of metal braces 84, 85 that extend from first side 82 adjacent to ends 78 and 80, respectively, and connect to opposite sides of frame member 70. Braces 84, 85 are connected to frame members 70 and 72 by welding. The upper surfaces of frame members 70, 72 and braces 84, 85 are generally oriented in a common plane.

Received within and extending from first end 74 and second end 76 of longitudinal frame member 70 are tubular members 86, 88. Tubular members 86, 88 are 2.5 inch square metal tubing that can extend from and retract within frame member 70. In one embodiment, tubular member 86 has a length of about 54 inches. As shown in FIG. 2, tubular member 86 is substantially retracted within frame member 70. Frame member 70 is provided with a hole 90 which aligns with a complimentary hole in tubular member 86 to secure member 86 in the retracted position, such as with a bolt or a spring loaded pin. In the retracted position as shown, tubular member 86 extends from frame member 70 by about 11.5 inches. The outer-most end 94 of tubular member 86 is connected to a ball hitch connector 96 for towing the mobile hydraulic lift with a vehicle, such as an all terrain vehicle or a utility or passenger vehicle. Tubular member 86 is provided with a second hole 92 about 42 inches from the outer-most end 94 of tubular member 86, which allows tubular member 86 to be extended and secured relative to frame member 70 by aligning hole 92 with hole 90 and inserting a bolt/pin. Jackstand 28 is mounted to tubular member 86 adjacent to the outer-most end 94 of tubular member 86 to support tubular member 86/frame member 70 at a desired distance above the ground when the ball hitch connector 96 is disconnected from a vehicle.

In one embodiment, tubular member 88 has a length of about 28 inches and is shown in an extended position. To secure tubular member 88 in the extended position, frame member 70 is provided with a hole 98 adjacent to end 76 of frame member 70. Hole 98 aligns with a hole provided in tubular member 88 and a bolt or pin is inserted to secure tubular member 88 relative to frame member 70. Tubular member 88 is provided with a second hole 100 adjacent to the outer-most end 102 of tubular member 88 to secure tubular member 88 in a retracted position. Jackstand 30 is secured to tubular member 88 adjacent to end 102 of tubular member 88 to aid in supporting end 76 of frame 20 when the platform 18 is elevated.

As further shown in FIG. 2, transverse frame member 72 also includes first and second tubular members 106, 108, which are slideably received within ends 78, 80, respectively. The outer-most end of tubular members 106, 108 carries a stub axle on which are mounted wheels 110. Tubular members 106, 108 are shown in an extended position and are maintained in that position by aligning holes 112 formed near ends 78, 80 with complimentary holes in tubular members 106, 108 and inserting a bolt/pin as previously described. Tubular members 106, 108 are also provided with holes 114 near wheels 110 which align with holes 112 for securing tubular members in a retracted position with wheels 110 adjacent to ends 78, 80. In one embodiment, tubular members 106, 108 are formed from 2.5 inch square tubing each having a length of about 25 inches. In the extended position, tubular members 106, 108 extend by about 19 inches from ends 78, 80.

Tubular members 86, 88, 106, 108 are secured in the retracted position for transporting the mobile hydraulic lift system to a desired location, and are secured in the extended position to increase the footprint of chassis 14 and to provide a stable base for supporting platform 18 in an elevated position. To set up chassis 14 for elevation of platform 18, ball hitch connector 96 is uncoupled from the towing ball of the vehicle and jackstands 28 and 30 are deployed to engage the ground. Tubular members 86, 88 are then extended and secured in the manner previously described. One of jackstands 28 and 30 is then extended to allow the chassis 14 to tilted to a point where the weight of the mobile hydraulic lift 10 is supported on jackstand 28, jackstand 30 and one of wheels 110, e.g., of tubular member 106. With the weight of mobile hydraulic lift 10 supported on these three points, the opposite wheel 110 of tubular member 108 is slightly elevated off of the ground allowing tubular member 108 to be extended and secured in the extended position. The chassis 14 is then tilted to support the weight of mobile hydraulic lift 10 on jackstand 28, jackstand 30 and the wheel 110 of the extended tubular member, e.g., tubular member 108, thereby slightly raising wheel 110 of tubular member 106 off of the ground. Tubular member 106 is the extended and secured in the extended position. Jackstands 28 and 30 are then adjusted to level chassis 14. In one embodiment a bubble level is mounted at a convenient location on mobile hydraulic lift to ensure chassis 14 is generally level before platform 18 is raised.

As further shown in FIG. 2, chassis 14 includes a pair of spaced tubular metal members 120 that flank longitudinal frame member 70. A first end portion 122 of each member 120 is supported on transverse frame member 72, and a second end portion 124 of each member 120 is supported on braces 84, 85. In one embodiment, tubular members 120 are formed from 1.5 inch square tubing. Tubular members 120 are secured to transverse frame member 72 and braces 84, 85 by welding. Tubular members 120 serve as a base for connecting and supporting first end 40 of hydraulic cylinder 34.

As also shown in FIG. 2, transverse frame member 72 further carries first and second spaced cantilevered metal tubes 126, which extend rearward. An end portion 128 of tubes 126 are secured to the top surface of transverse frame member 72 by welding. In one embodiment, metal tubes 126 are 2 inch square metal tubes having a length of about 19 inches. Metal tubes 126 provide supports for the battery-operated hydraulic system 36.

FIG. 3 is a cross-sectional view of the mobile hydraulic lift system 10 taken along line 3-3 of FIG. 1. As shown in FIG. 3, hydraulic cylinder 34 is located forward of transverse frame member 72 and is supported on tubular members 120, which ensures that the center of weight of platform 18 is forward of wheels 110. Hydraulic cylinder 34 is supported by a plurality of metal legs 44 each of which have a first end 132 welded to a portion of frame 20 and a second end 134 connected to the metal collar 46 secured about the base housing 38 of hydraulic cylinder 34. Collar 46 includes a pair of spaced mounting flanges 136 at opposite ends of collar 46. In one embodiment, flanges 136 are generally oriented toward first end 74 of frame member 70 to align leg 130A with longitudinal frame member 70. The first end 132 of leg 130A is welded to longitudinal frame member 70. Second end 134 of leg 130A and flanges 136 are provided with mounting holes. Second end 134 is positioned between flanges 136 and is secured to flanges 136 by a bolt, which also causes collar 46 to tighten around and become secured to the base housing 38 of hydraulic cylinder 34.

Collar also includes flanges 138 and 140 which are radially spaced from flanges 136 and are generally oriented toward ends 78, 80 of transverse frame member 72. Flanges 136, 138 and 140 are secured to collar 46 by welding. Second ends 134 of legs 130B and 130C and flanges 138 and 140 are also provided with mounting holes. Second ends 134 of leg 130B and 130C are secured to flanges 138 and 140, respectively by a bolt. The first ends 132 of legs 130B and 130C are secured to transverse frame member 72 adjacent to ends 80 and 78, e.g., by welding.

As further shown in FIG. 3, the battery-operated hydraulic system 36 is supported on a plate 142 that is secured to metal tubes 126. Hydraulic system 36 generally comprises a 12 volt battery 144, a solar panel 146 that is connected to battery 144 for charging battery 144, and a hydraulic fluid reservoir/pump 148 that is electrically connected to battery 144 with a hydraulic connection to hydraulic cylinder 34.

Telescoping rod 60 is secured to longitudinal frame member 70 adjacent to second end 76 and is supported by a pair of support legs 150. A first end 152 of each support leg 150 is welded to and end portion of metal tubes 126, and a second end 154 of each support leg 150 is welded to opposite sides of rod 60. Rod 60 prevents rotation of platform 18 about its connection to hydraulic cylinder 34.

FIG. 4 is an enlarged partial perspective view of the first end 40 of hydraulic cylinder 34 shown connected to tubular members 120. Tubular members 120 each include a cylindrical metal sleeve 160 welded to the upper surface of tubular members 120. Sleeves 160 are oriented to receive a hub 162 of hydraulic cylinder 34 therebetween. A pin 164 extends through sleeves 160 and hub 162 to secure first end 40 of hydraulic cylinder 34 to frame 20. An end portion of pin 164 is provided with a hole transverse to the axis of the pin to receive a retainer, such as a bolt, to hold pin 164 in place.

FIG. 5 is an exploded partial perspective view of central beam 58 relative to hydraulic cylinder 34. FIG. 5A is a partial perspective view of one embodiment of a connection of hydraulic cylinder 34 to the central beam 58 of platform 18. FIG. 6 is a cross-sectional view of the connection of hydraulic cylinder 34 to central beam 58. In one embodiment, central beam 58 is a hollow, rectangular steel beam. As shown in FIGS. 5, 5A and 6, central beam 58 is configured with an opening 170 at a mid point of beam 58 by removing a portion of the lower beam wall 172 and side walls 174 so as to expose a horizontal edge 175 of each side wall 174 that is generally parallel to and spaced from lower beam wall 172. Opening 170 is sized to receive a rod end connector 173 of hydraulic cylinder 34 between side walls 174 with the horizontal edges 175 engaging a planar portion 177 of rod end 179 adjacent to rod end connector 173. The side walls 174 of beam 58 above opening 170 are configured with a hole that aligns with a hole in rod end connector 173 to receive a bolt 176 for connecting the rod end connector 173 of hydraulic cylinder relative to beam 58. In one embodiment, side walls 174 may be reinforced with a metal plate 178 adjacent to the bolt connection. Platform 18 is maintained in a generally horizontal position as a result of the engagement of horizontal edges 175 of beam side walls 174 with the planar portion 177 of rod end 179 and bolt connection of rod end connector 173 to side walls 174.

As shown in FIGS. 5 and 5A, an opening 180 is formed adjacent to bolt 176 to provide access to a bleeder valve 182 associated with the rod end connector 173. As further shown in FIG. 5A, platform 18 may be reinforced by one or more cross bracing members 184 from central beam 58 to one or more locations on the perimeter frame members 56 of deck frame 50 that are parallel to central beam 58. In one embodiment, cross bracing member 184 is formed from angle iron and is connected to central beam 58 and perimeter frame members 56 by welding.

FIG. 7 is a side view of the mobile hydraulic lift system 10 in a deployed condition. As shown in FIG. 7, tubular members 86 and 88 are extended relative to longitudinal frame member 70 and jackstands 28, 30 have been positioned to engage the ground and level frame 20. Second tubular members 106, 108 also extend from transverse frame member 72 as previously described. In one embodiment, frame 20 has a first length and width of about 4 feet by 4 feet when tubular members are in a retracted position, and a second length and width of about 8 feet by 8 feet when tubular members are in an extended position. Frame 20 thus provides a stable base to support platform 18 in an elevated position.

Platform 18 is elevated by a control 190 electrically connected to the hydraulic pump of hydraulic system 16, which activates the hydraulic pump to extend hydraulic cylinder 34. In one embodiment, hydraulic cylinder 34 is a three-stage hydraulic cylinder which supports platform 18 at a height of about 5 feet when hydraulic cylinder 34 is fully retracted (FIG. 1) and can elevate platform 18 to a height of about 12 feet when hydraulic cylinder 34 is fully extended.

As shown in FIG. 7 and 8, rod 60 is comprised of two rod sections 60A, 60B. In one embodiment, rod section 60A is comprised of square metal tubing and rod section 60B is comprised of round metal tubing. Rod section 60B has an outer diameter less than the inner diameter of rod section 60A which aids in preventing rod 60 from binding as platform 18 is raised and lowered. A guide 192 having a round opening sized slightly large than rod section 60B is fitted within end 194 of rod section 60A. Rod section 60B extends through guide 192. Guide 192 is formed from a polymer and functions to keep rod section 60B centered within rod section 60A and minimize frictional contact between rod sections 60A, 60B. Rod section 60B is connected to a portion of railing 54 by a bridging metal section 196 that is welded to rod section 60B and railing 54.

The hydraulic lift of the present invention is relatively lightweight and compact for ease of transporting the lift over soft and/or heavily vegetated terrain, such as with an ATV. The frame of the chassis can be easily and quickly adjusted to increase the footprint of the frame to provide a stable base for the lift. The use of a single, multi-stage hydraulic cylinder connected relative to a central beam of the platform provides a simple, quick and relatively inexpensive means for elevating a platform in remote areas commonly sought for observing or hunting wild game.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A mobile hydraulic lift comprising:
a trailer having a trailer frame, the trailer frame having a variable length first end member and a variable length second end member, the trailer frame further having a variable length first side member and a variable length second side member, the trailer frame defining a first footprint with the first and second end members and the first and second side members are in a first position, the trailer frame defining a second footprint greater than the first footprint when the first and second end members and the first and second side members are in a second position, the first and second end members each configured with a ground contact device and the first and second side members each carrying a wheel;
a multi-stage hydraulic cylinder having first, second and third cylinder sections, a first end of the first cylinder section connected to the trailer frame, a first end of the third cylinder section defining a connector, the hydraulic cylinder operably coupled to a battery-operated hydraulic system comprising a hydraulic reservoir and a hydraulic pump, the first cylinder section being maintained generally perpendicular to the trailer frame by a support connected between the first cylinder section and the trailer frame; and
a platform having a perimeter deck frame comprised of a plurality of deck frame members and a central box beam extending between and connected to two opposing perimeter deck frame members at their respective midpoints, the deck frame and the box beam having an upper surface supporting a deck of the platform, the box beam further having lower surface, the connector of the hydraulic cylinder connected to the central box beam.

2. The mobile hydraulic lift of claim 1 wherein a centrally located portion of the box beam lower surface is configured to define an opening having a width, the connector of the hydraulic cylinder third section extending through the opening and positioned between opposing side walls of the box beam, a portion of the box beam supported on upper surface portions of the third cylinder section, the connector of the hydraulic cylinder and the opposing side walls configured to receive a bolt for connection of the box beam to the hydraulic cylinder.

3. The mobile hydraulic lift of claim 1 wherein the platform further comprises a railing connected to the perimeter deck frame and a telescoping rod having a first portion connected to the trailer frame and a second portion connected to the railing.

4. The mobile hydraulic lift of claim 1 wherein the support comprises a collar secured to the first cylinder section adjacent to a second end of the first cylinder section and a plurality of legs radially spaced about the collar, each leg of the plurality of legs connected between the collar and a portion of the trailer frame.

5. The mobile hydraulic lift of claim 4 wherein the collar comprises a plurality of radially extending tabs, each leg of the plurality of legs having a first end connected to a respective tab on the collar, each leg of the plurality of legs having a second end welded to the trailer frame.

6. A mobile hydraulic lift comprising:
a trailer comprising:
a longitudinal tubular frame member having a first end and a second end, a first telescoping member slideable within the first end of the tubular frame member, and a second telescoping member slideable within the second end of the tubular frame member, the first and second telescoping members moveable between a first position substantially within the tubular frame member and a second position extending from the tubular frame member, each of the first and second telescoping frame members being connected to a jackstand;
a transverse tubular frame member connected to the longitudinal frame member, the transverse tubular frame member having a first end and a second end, a third telescoping member slideable within the first end of the transverse tubular frame member and a fourth telescoping member slideable within the second end of the transverse tubular frame member, the third and fourth telescoping members moveable between a first position substantially within the transverse tubular frame member and a second position extending from the transverse tubular frame member, each of the third and fourth telescoping members being connected to a wheeled axle;
a first brace connected between the transverse tubular frame member and a first side of the longitudinal tubular frame member;
a second brace connected between the transverse tubular frame member and a second side of the longitudinal tubular frame member;
a base supported on the trailer;
a telescoping hydraulic cylinder having a plurality of nesting cylinder sections, a first cylinder section defining a first end of the telescoping hydraulic cylinder and a second cylinder section defining a second end of the telescoping hydraulic cylinder, the first end of the telescoping hydraulic cylinder being connected to the base of the trailer, the second end of the telescoping hydraulic cylinder being connected to a central support member of a platform;
a plurality of support legs each having a first end connected to an outer surface portion of the first cylinder section, the outer surface portion being spaced from the first end of the hydraulic cylinder, each of the plurality of legs having a second end connected to one of the longitudinal frame member and the transverse frame member; and
means connected to the hydraulic cylinder for actuating the hydraulic cylinder to elevate the platform.

7. The mobile hydraulic lift of claim 6 wherein the platform comprises a perimeter frame having a plurality of frame members and a central box beam, the central box beam connected to two opposing frame members at their respective midpoints, the box beam having a lower wall, an upper wall and a pair of side walls connecting the upper and lower walls, a portion of the lower wall and side walls configured to define an opening having width, the second end of the hydraulic cylinder configured to define a connector, the connector sized to fit within the opening of the box beam to be positioned between the side walls of the box beam, means for connecting the connector to the box beam, wherein a portion of the box beam is supported on an upper portion of the second cylinder section.

8. The mobile hydraulic lift of claim 6 and further comprising a telescoping rod having first and second rod sections, the first rod section connected to the trailer, the second rod section being connected to the platform.

9. A mobile hydraulic lift comprising:
a trailer having first and second wheels on opposite sides of the trailer and means at one end of the trailer for connecting the trailer to a vehicle, the trailer having a plurality of structural members;
a multi-stage hydraulic cylinder having a first end connected to the trailer, and a second end, the second end defining a connector;
means connected between the hydraulic cylinder and the trailer for supporting the hydraulic cylinder in a generally perpendicular position relative to the trailer;
a platform comprising a generally parallelogram frame having a plurality of perimeter frame members and a central box beam positioned generally midway between a first pair of opposing frame members and connected to a second pair of opposing frame members, the frame and the box beam supporting a deck, the box beam having a lower wall, and upper wall and a pair of side walls connected to the upper and lower walls, a portion of the lower wall and side walls configured to define an opening, the connector of the hydraulic cylinder extending through the opening and positioned between the pair of side walls of the box beam; and
means for connecting the connector of the hydraulic cylinder to the pair of side walls of the box beam.

10. The mobile hydraulic lift of claim 9 wherein the hydraulic cylinder has an upper surface portion adjacent to the connector, the upper surface portion being generally parallel with the lower wall of the box beam, wherein a portion of the side walls of the box beam is supported on the upper surface portion of the hydraulic cylinder on opposite sides of the opening.

11. The mobile hydraulic lift of claim 9 wherein the trailer comprises means for supporting the trailer relative to the ground at a plurality of spaced points.

12. The mobile hydraulic lift of claim 10 wherein the platform further comprises a railing supported relative to the frame, the railing being connected to a telescoping rod connected to the trailer.

13. The mobile hydraulic lift of claim 10 wherein the means for supporting the hydraulic cylinder comprises:
a collar connected to a first housing of the hydraulic cylinder, the collar having a plurality of radially spaced tabs extending radially from the collar;
a plurality of legs, each leg of the plurality of legs having a first end connected to one of the plurality of spaced tabs, each leg of the plurality of legs having a second end connected to the trailer.
